(19) United States
(12) Patent Application Publication
(10) Pub. No.: US 2023/0394035 A1
(43) Pub. Date: Dec. 7, 2023

(54) SYSTEMS AND METHODS FOR REFINING HOUSE CHARACTERISTIC DATA USING ARTIFICIAL INTELLIGENCE AND/OR OTHER TECHNIQUES

(71) Applicant: STATE FARM MUTUAL AUTOMOBILE INSURANCE COMPANY, Bloomington, IL (US)

(72) Inventors: Puneit Dua, Bloomington, IL (US); Joshua James Wiggs, Bloomington, IL (US); Matt Corbin, Hudson, IL (US); Dustin Helland, Morton, IL (US)

(21) Appl. No.: 18/235,220

(22) Filed: Aug. 17, 2023

Related U.S. Application Data
(63) Continuation of application No. 17/978,016, filed on Oct. 31, 2022.
Application No. 17/978,016 is a continuation of application No. 17/700,912, filed on Mar. 22, 2022.
(60) Provisional application No. 63/302,402, filed on Jan. 24, 2022.

(51) Int. Cl. G06F 16/23

(52) U.S. Cl. CPC G06F 16/2365; G06F 16/2358; G06Q 50/163

(57) ABSTRACT

The following relates generally to generating a property measurement (e.g., a property value, a construction replacement cost, a property health score, etc.) of a subject property, and, more particularly, to generating a property measurement of the subject property when at least one property parameter of the subject property is unknown or inaccurate. In some embodiments, a set of properties nearby the subject property is identified, and information of the set of properties is received. At least one property parameter (e.g., a year built, a square footage, a qualitative build grade of the subject property, etc.) is optimized. The property measurement of the subject property may then be optimized based upon the determined at least one property parameter.

### CROSS REFERENCE TO RELATED APPLICATIONS

This application is a continuation of and claims priority to U.S. application Ser. No. 17/978,016 filed on Oct. 31, 2022, entitled “Systems and Methods for Refining House Characteristic Data Using Artificial Intelligence and/or Other Techniques,” which is a continuation of and claims priority to U.S. application Ser. No. 17/700,912 filed on Mar. 22, 2022, entitled “Systems and Methods for Refining House Characteristic Data Using Artificial Intelligence and/or Other Techniques,” which claims the benefit of (1) U.S. Provisional Patent Application No. 63/283,210, entitled “Techniques for Automatically Determining Characteristics for Properties to Assess Property Value,” filed Nov. 24, 2021; and (2) U.S. Provisional Patent Application No. 63/302,402, entitled “Systems and Methods for Refining House Characteristic Data Using Artificial Intelligence and/or Other Techniques,” filed Jan. 24, 2022. U.S. Provisional Patent Application Nos. 63/283,210, and 63/302,402 are hereby expressly incorporated by reference herein in their entirety.

### FIELD

The present disclosure generally relates to assessing property values and/or other property measurements; and more particularly relates to automatically determining property characteristics to assess property values and/or make other property measurements.

### BACKGROUND

Current systems for determining property values and/or other property measurements (e.g., property construction replacement costs, property health score, etc.) often produce inaccurate results. For instance, when certain property data is not available, current systems calculate a property value by ignoring the property characteristics that are unknown, which produces an inaccurate property value estimate.

The systems and methods disclosed herein provide solutions to these problems, and may provide solutions to other drawbacks, inaccuracies, and inefficiencies of conventional techniques.

### SUMMARY

The present embodiments may be related to refinement of house characteristics, and in turn generation of a repair or replacement cost, or a property value. The techniques described herein may be particularly useful when a parameter (e.g., square footage, year built, build grade, etc.) of a subject property is unknown. For instance, the techniques described herein may use a machine learning algorithm to accurately generate a property value even if a property parameter is unknown.

In one aspect, a computer-implemented method for use in generating a property measurement of a subject property may be provided. The method may be implemented via one or more local or remote processors, servers, sensors, transceivers, memory units, and/or aerial vehicles. The method may include: (1) identifying, by one or more processors, a set of properties based upon a location of the subject property; (2) receiving, by the one or more processors, information of the set of properties; and/or (3) optimizing, by the one or more processors, at least one property parameter of the subject property based upon the received information of the set of properties, the at least one property parameter comprising: (i) a year built of the subject property, (ii) a square footage of the subject property, and/or (iii) a qualitative build grade of the subject property. The method may include additional, fewer, or alternate actions, including those discussed elsewhere herein.

In another aspect, a computer system configured for use in generating a property measurement of a subject property may be provided. The computer system may comprise one or more processors configured to: (1) identify a set of properties based upon a location of the subject property; (2) receive information of the set of properties; and/or (3) optimize at least one property parameter of the subject property based upon the received information of the set of properties, the at least one property parameter comprising: (i) a year built of the subject property, (ii) a square footage of the subject property, and/or (iii) a qualitative build grade of the subject property. The computer system may include additional, less, or alternate functionality, including that discussed elsewhere herein.

In yet another aspect, a computer system for generating a property measurement of a subject property may be provided. The computer system may comprise one or more processors. The computer system may further comprise a program memory coupled to the one or more processors and storing executable instructions that, when executed by the one or more processors, cause the computer system to: (1) identify a set of properties based upon a location of the subject property; (2) receive information of the set of properties; and/or (3) optimize at least one property parameter of the subject property based upon the received information of the set of properties, the at least one property parameter comprising: (i) a year built of the subject property, (ii) a square footage of the subject property, and/or (iii) a qualitative build grade of the subject property. The non-transitory computer readable medium may include instructions that direct additional, less, or alternate functionality, including that discussed elsewhere herein.

The systems and methods disclosed herein advantageously improve accuracy of a machine learning algorithm's and/or model's generation of a property value when a property parameter of a subject property is unknown or inaccurate.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The Figures described below depict various aspects of the applications, methods, and systems disclosed herein. It should be understood that each Figure depicts an embodiment of a particular aspect of the disclosed applications, systems and methods, and that each of the Figures is intended to accord with a possible embodiment thereof. Furthermore, wherever possible, the following description refers to the reference numerals included in the following Figures, in which features depicted in multiple Figures are designated with consistent reference numerals.

FIG. 1 illustrates an exemplary computer system for generating a property value.

FIG. 2 illustrates a high-level exemplary flowchart of generating a property value.

FIG. 3 illustrates an example of training a machine learning (ML) algorithm, in accordance with some embodiments.

FIG. 4A illustrates an exemplary simulation illustrated by a graph of a number of properties for which the error is calculated vs. absolute percent residual where the at least one property parameter is square footage.

FIG. 4B illustrates an exemplary simulation illustrated by a graph of a number of properties for which the error is calculated vs. absolute percent residual where the at least one property parameter is year built.

FIGS. 5A and 5B illustrate an exemplary implementation of a computer system for generating a property value, with FIG. 5B being a continuation of FIG. 5A.

FIG. 6 illustrates a flowchart of an exemplary computer-implemented method for generating a property value.

FIG. 7 illustrates a computer-implemented method of creating a trusted property profile.

### DETAILED DESCRIPTION

The present embodiments relate to, inter alia, automatically determining and/or refining property characteristics to assess property values and/or make other property measurements.

Current systems for determining property values often produce inaccurate results. For instance, when certain property data is not available, current systems may calculate a property value based only upon the known property characteristics, which produces an inaccurate property value estimate.

The systems and methods described herein address this problem and others. For instance, the present embodiments may more accurately estimate the value of a home, and in turn, allow for more accurately matching price to risk when generating homeowners insurance quotes, and may facilitate more efficient insurance claim handling and repairing home damage. In some embodiments, when a property parameter (e.g., a year built, a square footage, and/or a qualitative build grade of the property, etc.) is unknown, rather than simply exclude the property parameter from the property value calculation, a property parameter to be used for the property value calculation is determined based upon information of nearby properties.

As used herein, unless specified otherwise, the term square footage of the subject property refers to an indoor square footage of the subject property (e.g., an indoor square footage of a structure of the subject property).

### Exemplary Computer System for Assessing Property Values

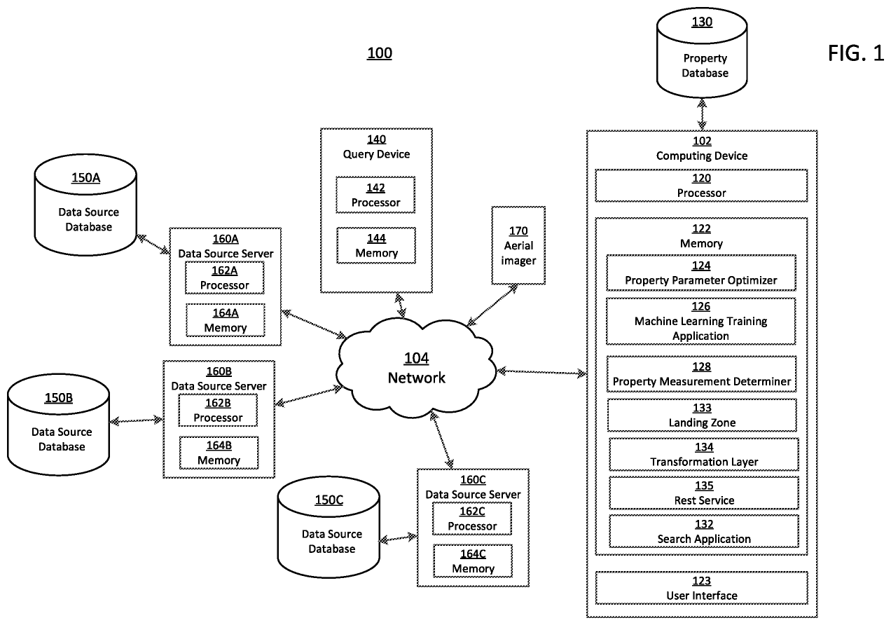

FIG. 1 illustrates an exemplary computer system 100 for generating a property value of a subject property. The high-level architecture illustrated in FIG. 1 may include both hardware and software applications, as well as various data communications channels for communicating data between the various hardware and software components, as is described below. The system may include a computing device 102, which, as will be explained further below, may be configured to generate a property measurement (e.g., a property value, a property construction replacement cost, a property health score, etc.) of a subject property.

The computing device 102 may be further configured to communicate, e.g., via a network 104 (which may be a wired or wireless network), with data source servers 160A, 160B, 160C associated with various data sources (e.g., public records data, a multiple listing service (MLS) database, data servers of public tax assessor information, etc.). Although three data source servers 160A, 160B, 160C associated with three separate data sources are shown in FIG. 1, a greater or lesser number of data source servers may be included in various embodiments. The data source servers 160A, 160B, 160C may each respectively be associated with data source databases 150A, 150B, 150C storing, inter alia, property data (e.g., a year built, a square footage, and/or a qualitative build grade of the property, etc.). In some embodiments, the data source servers 160A, 160B, 160C may be data servers holding market listing information (e.g., servers of websites listing properties for sale, etc.) and/or data servers of public tax assessor information.

Furthermore, the data source servers 160A, 160B, 160C may each respectively include one or more processors 162A, 162B, 162C, such as one or more microprocessors, controllers, and/or any other suitable type of processor. The data source servers 160A, 160B, 160C may each respectively further include a memory 164A, 164B, 164C (e.g., volatile memory, non-volatile memory) accessible by the respective one or more processors 162A, 162B, 162C, (e.g., via a memory controller). The respective one or more processors 162A, 162B, 162C may each interact with the respective memories 164A, 164B, 164C to obtain, for example, computer-readable instructions stored in the respective memories 164A, 164B, 164C. Additionally or alternatively, computer-readable instructions may be stored on one or more removable media (e.g., a compact disc, a digital versatile disc, removable flash memory, etc.) that may be coupled to the data source servers 160A, 160B, 160C to provide access to the computer-readable instructions stored thereon. In particular, the computer-readable instructions stored on the respective memories 164A, 164B, 164C may include instructions for transmitting or receiving property information to or from other devices connected to the network 104.

The computing device 102 may further include a search application 132, which may provide a search feature to be displayed to a user via, e.g., via a web interface or via the user interface 123. In one example, the search application 132 may receive user input indicating a property. The user input may indicate an address and/or geographic identifier (e.g., zip code, country, city, state, latitude, longitude, etc.) of a property. Additionally or alternatively, the user input may include property characteristics (e.g., year built, square footage, build grade, any of the at least one property parameters, etc.). For instance, the user may input may indicate a zip code along with a range of square footages to search for. As such, the search application 132 may return a result of only a single property or a list of properties, and thus user interface may display information of a single property, or of a plurality of properties (e.g., display a list of properties).

The computing device 102 may be further configured to communicate with query device 140. In some embodiments, the query device 140 is a device (e.g., computer, tablet, smartphone, phablet, etc.) of an insurance agent seeking to prepare a quote for homeowners insurance. In other embodiments, the query device 140 is a device (e.g., computer, tablet, smartphone, phablet, mobile device, etc.) of any individual, company, and/or entity seeking generation of or access to a property value.

The query device 140 may include one or more processors 142, such as one or more microprocessors, controllers, and/or any other suitable type of processor. The query device 140 may further include one or more memories 144 (e.g., volatile memory, non-volatile memory) accessible by the respective one or more processors 142, (e.g., via a memory controller). The respective one or more processors 142 may each interact with the one or more memories 144 to obtain, for example, computer-readable instructions stored in the one or more memories 144. Additionally or alternatively, computer-readable instructions may be stored on one or more removable media (e.g., a compact disc, a digital versatile disc, removable flash memory, etc.) that may be coupled to the query device 140 to provide access to the computer-readable instructions stored thereon.

In some embodiments, the computing device 102 may receive, via wireless communication over one or more radio frequency links, data or images associated with a home from the query device 140. For instance, an individual looking to purchase a home, may take several photos of a home via a camera on their mobile device (i.e., query device 140). The individual may take photos of the home's yard, interiors, kitchen, countertops, flooring, roofing, basement, bathrooms, bedrooms, living room, windows, etc. The individual may then send the images to the computing device 102 via their mobile device, such as to ask for, and receive via their mobile device, a homeowners insurance quote for the home for which they submitted photos of. The insurance quote may be based upon the pre-existing data known about the home, the additional photos received from the customer's mobile device, and/or the home valuation techniques discussed herein.

The computing device 102 may be further configured to communicate with aerial imager 170. The aerial imager may be any suitable device or system configured to gather data of the property. For instance, the aerial imager 170 may be a manned aerial vehicle, a drone (e.g., an unmanned aerial vehicle (UAV)), a satellite configured to capture photographic information, etc. The aerial imager 170 may be configured to gather data of any property in any way. For instance, if the aerial imager 170 is a manned aerial vehicle or a drone, the aerial imager 170 may be equipped with light detection and ranging (LIDAR) camera(s), photographic camera(s), video camera(s), radio detection and ranging (RADAR) equipment, and/or infrared equipment. The aerial imager 170 may use any of the devices that it is equipped with to gather data of any property (e.g., the exterior or interior of the subject property), including the subject property. For instance, the aerial imager 170 may use a LIDAR camera to measure dimensions of the exterior of the subject property.

The computing device 102 may include one or more processors 120, such as one or more microprocessors, controllers, and/or any other suitable type of processor. The computing device 102 may further include a memory 122 (e.g., volatile memory, non-volatile memory) accessible by the one or more processors 120, (e.g., via a memory controller). Additionally, the computing device 102 may include a user interface 123.

The one or more processors 120 may interact with the memory 122 to obtain, for example, computer-readable instructions stored in the memory 122. Additionally or alternatively, computer-readable instructions may be stored on one or more removable media (e.g., a compact disc, a digital versatile disc, removable flash memory, etc.) that may be coupled to the computing device 102 to provide access to the computer-readable instructions stored thereon. In particular, the computer-readable instructions stored on the memory 122 may include instructions for executing various applications, such as, e.g., a property parameter determiner 124, a machine learning model training application 126, and/or a property value determiner 128.

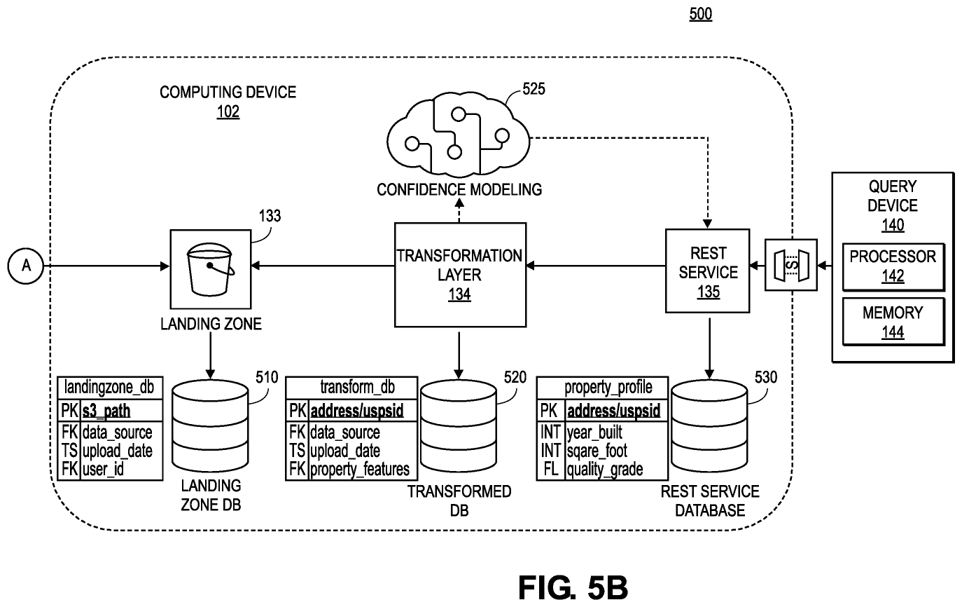

The computing device 102 may store data in the property database 130. For instance, any property information, determined property parameters, generated property values, models, algorithms, and/or machine learning algorithms may be stored in the property database 130. The memory 122 may further include landing zone 133, transformation layer 134, rest service 135, and/or search application 132, which will be described in more detail with respect to FIGS. 5A and 5B.

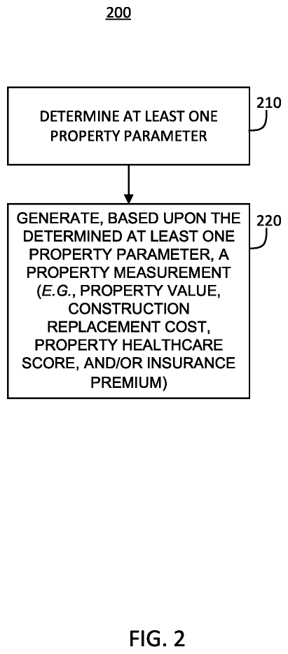

In general, the computing device 102 may generate a property value or other property measurement based upon property parameters (e.g., a year built, a square footage, and/or a qualitative build grade of the property, etc.). Very broadly speaking, some embodiments use a two-step process to generate the property value or other property measurement, as illustrated in the example flowchart 200 of FIG. 2.

With reference thereto, at block 210 the at least one property parameter is determined. For instance, the at least one property parameter may correspond to a characteristic of the subject property (e.g., year built, square footage, and/or qualitative build grade of the subject property) whose actual value is unknown or inaccurate. For instance, the actual square footage of a subject property may be unknown; and thus, at block 210, at least one property parameter comprising square footage of the subject property may be determined. The at least one property parameter may be determined in any suitable manner. For example, if the at least one property parameter comprises the square footage, the at least one property parameter may be determined by taking an average square footage of nearby properties. In another example, a trained machine learning algorithm may be used to determine the at least one property parameter by taking information from nearby properties as inputs.

Subsequently, at block 220, the property measurement may be generated based upon the determined at least one property parameter. The property measurement may be generated in any suitable way, such as by inputting the determined at least one property parameter into a trained machine learning algorithm. If a machine learning algorithm is used at both blocks 210 and 220, the machine learning algorithm used at block 220 may be the same or different machine learning algorithm that was used at block 210. In this way, some embodiments use two machine learning algorithms: a first machine learning algorithm (e.g., a property parameter machine learning algorithm) to determine the at least one property parameter, and a second machine learning algorithm (e.g., a property measurement machine learning algorithm) to generate the property measurement (e.g., a property value, a construction replacement cost, a property health score, etc.) of the subject property.

### Training & Using Machine Learning Algorithm(s) to Determine Property Parameter(s) & Property Measurement(s)

As mentioned above, some embodiments use two machine learning algorithms: a first machine learning algorithm to determine the at least one property parameter, and a second machine learning algorithm to generate the property measurement of the subject property. However, the two machine learning algorithms do not necessarily need to be separate, and thus, in other embodiments, only one machine learning algorithm is used to determine both the at least one property parameter and generate the property measurement of the subject property. In still other embodiments, the at least one property parameter is determined without the use of a machine learning algorithm while the property measurement of the subject property is generated with the use of a machine learning algorithm. In still other embodiments, the at least one property parameter is determined with the use of a machine learning algorithm while the property measurement of the subject property is generated without the use of a machine learning algorithm.

The following presents a discussion on any of the machine learning techniques in accordance with the systems and methods described herein. In some embodiments, these techniques are performed, wholly or partially, by any of the property parameter determiner 124, the machine learning training application 126, the property measurement determiner 128, and/or any other suitable component.

In general, training the machine learning model may include establishing a network architecture, or topology, and adding layers that may be associated with one or more activation functions (e.g., a rectified linear unit, softmax, etc.), loss functions and/or optimization functions. Multiple different types of artificial neural networks may be employed, including without limitation, recurrent neural networks, convolutional neural networks, and deep learning neural networks. Data sets used to train the artificial neural network(s) may be divided into training, validation, and testing subsets; these subsets may be encoded in an N-dimensional tensor, array, matrix, or other suitable data structures. Training may be performed by iteratively training the network using labeled training samples. Training of the artificial neural network may produce byproduct weights, or parameters which may be initialized to random values. The weights may be modified as the network is iteratively trained, by using one of several gradient descent algorithms, to reduce loss and to cause the values output by the network to converge to expected, or “learned,” values.

In one embodiment, a regression neural network may be selected which lacks an activation function, wherein input data may be normalized by mean centering, to determine loss and quantify the accuracy of outputs. Such normalization may use a mean squared error loss function and mean absolute error. The artificial neural network model may be validated and cross-validated using standard techniques such as hold-out, K-fold, etc. In some embodiments, multiple artificial neural networks may be separately trained and operated, and/or separately trained and operated in conjunction.

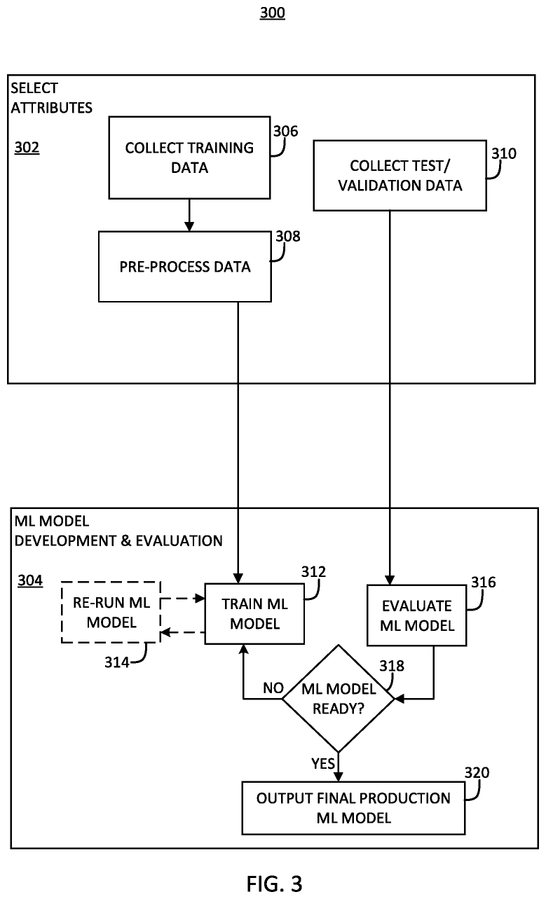

FIG. 3 is a block diagram of an example machine learning modeling method 300 for training and evaluating a machine learning model (e.g., a machine learning algorithm), in accordance with various embodiments. It should be understood that the principles of FIG. 3 may apply to any machine learning algorithm discussed herein. As mentioned, in some embodiments, the machine learning model may be used to determine at least one property parameter; additionally or alternatively, the machine learning algorithm may be used to generate a property measurement.

As illustrated in the example of FIG. 3, in some embodiments, the model “learns” an algorithm capable of determining at least one property parameter and/or generating a property measurement. At a high level, the machine learning modeling method 300 includes a block 302 for preparation of model input data, and a block 304 for model training and evaluation. The model training, storage, and implementation may be performed at the computing device 102 or any other suitable component. In some embodiments, the training, storage, and implementation steps of the machine learning model may be performed at different computing devices or servers. For example, the machine learning model may be trained at any of the computing device 102, the query device 140 and/or the data source servers 160A, 160B, 160C; the machine learning model may then be stored and implemented at any of the computing device 102, the query device 140, and/or the data source servers 160A, 160B, 160C.

Depending on implementation, one or more machine learning models may be trained at the same time. The different trained machine learning models may be further operated separately or in conjunction. Specific attributes in the training data sets may determine for which particular machine learning model each data set will be used. The determination may be made on attributes such as specific features of the information from the computing device 102 and/or any of the data source servers 160A, 160B, 160C. Training multiple machine learning models may provide an advantage of expediting calculations and further increasing specificity of prediction for each machine learning model's particular instance space. For instance, different machine learning models may be trained for different property parameters. For example, different machine learning algorithms may be trained to determine each of a year built, a square footage, and/or a qualitative build grade of the property.

Depending on implementation, the machine learning model may be trained based upon supervised learning, unsupervised learning, or semi-supervised learning. Such learning paradigms may include reinforcement learning. Supervised learning is a learning process for learning the underlying function or algorithm that maps an input to an output based on example input-output combinations. A “teaching process” compares predictions by the model to known answers (labeled data) and makes corrections in the model. The trained algorithm is then able to make predictions of outputs based on the inputs. In such embodiments, the data (e.g., information of properties, such as year built, square footage, build grade, property value, etc.) may be labeled according to the corresponding output (e.g., again information of properties, such as year built, square footage, build grade, property value, construction replacement cost, property health score, etc.).

Unsupervised learning is a learning process for generalizing the underlying structure or distribution in unlabeled data. In embodiments utilizing unsupervised learning, the system may rely on unlabeled property information, such as year built, square footage, build grade, and/or property value, etc. During unsupervised learning, natural structures are identified and exploited for relating instances to each other. Semi-supervised learning can use a mixture of supervised and unsupervised techniques. This learning process discovers and learns the structure in the input variables, where typically some of the input data is labeled, and most is unlabeled. The training operations discussed herein may rely on any one or more of supervised, unsupervised, or semi-supervised learning with regard to the order data and delivery data, depending on the embodiment.

Block 302 may include any one or more blocks or sub-blocks 306-310, which may be implemented in any suitable order. At block 306, the machine learning training application 126, executed by processor 120 according to instructions on program memory 122, may obtain training data from the computing device 102, the query device 140, aerial imager 170, and/or any of the data source servers 160A, 160B, 160C. The training data may include any suitable data, such as property values, year built, square footage, build grade, number of bathrooms, roof information, number of stories, kitchen countertop material, floor covering information, property use information, kitchen size, garage information (e.g., garage size and style information), cooling system information, heating system information, exterior wall finish information, foundation type, fireplace information, tax information, interior features, exterior features, proximity to a fire hydrant, etc.

Initially, at block 308, relevant data may be selected from among available data (e.g., historical data). Training data may be assessed and cleaned, including handling missing data and handling outliers. For example, missing records, zero values (e.g., values that were not recorded), incomplete data sets (e.g., for scenarios when data collection was not completed), outliers, and inaccurate and/or inconclusive data may be removed. In order to select high predictive value features, special feature engineering techniques may be used to derive useful features from the datasets. For example, data may be visualized for the underlying relationships to determine which feature engineering steps should be assessed for performance improvement. This step may include manually entering user input, for example via user interface 123, which may include defining possible predictive variables for the machine learning model. Manual user input may also include manually including or excluding variables selection after running special feature engineering techniques. Manual user input may be guided by an interest to evaluate, for example, an interaction of two or more predictor variables (e.g., which data source the data came from).

Furthermore, at block 308, various measures may be taken to ensure a robust set of training data (e.g., providing standardized, heterogeneous data, removing outliers, imputing missing values, and so on). In certain embodiments, special feature engineering techniques may be used to extract or derive the best representations of the predictor variables to increase the effectiveness of the model. To avoid overfitting, in some embodiments feature reduction may be performed. In some embodiments, feature engineering techniques may include an analysis to remove uncorrelated features or variables.

Variables may be evaluated in isolation to eliminate low predictive value variables, for example, by applying a cut-off value. For instance, some variables may have low predictive values for particular property parameters. For example, if a machine learning algorithm is being trained to determine a year built, it may be determined that variables such as property use information, kitchen size, and garage size have a low predictive value for determining the year built. Thus, in this example, the variables of property use information, kitchen size, and garage size may be eliminated during training so that the machine learning algorithm is wholly or partially trained without them. In another example, if a machine learning algorithm is being trained to determine a square footage, it may be determined that the variables of kitchen size, and garage size have a high predictive value for determining the square footage. Thus, in this second example, the variables of kitchen size, and garage size would not be eliminated while training the machine learning algorithm.

At block 310, the machine learning training application 126 receives test data for testing the model or validation data for validating the model (e.g., from one of the described respective data sources). Some or all of the training, test, or validation data sets may be labeled with pre-determined answers (e.g., based upon known information, predicted information, etc.).

Block 304 illustrates an example machine learning model development and evaluation phase. Block 304 may include any one or more blocks or sub-blocks 312-320, which may be implemented in any suitable order. In one example, at block 312, the training module trains the machine learning model by running one or more pre-processed training data sets described above. At block 314, the training module re-runs several iterations of the machine learning model. At block 316, the training module evaluates the machine learning model. At block 318, the training module determines whether or not the machine learning model is ready for deployment before either proceeding to block 320 to output final production model or returning to block 312 to further develop, test, or validate the model.

Regarding block 312, developing the model typically involves training the model using training data. At a high level, the machine learning model may be utilized to discover relationships between various observable features (e.g., between predictor features and target features) in a training dataset, which can then be applied to an input dataset to predict unknown values for one or more of these features given the known values for the remaining features. At block 304, these relationships are discovered by feeding the model pre-processed training data including instances each having one or more predictor feature values and one or more target feature values. The model then “learns” an algorithm capable of calculating or predicting the target feature values (e.g., to determine a property parameter, or generate a property value) given the predictor feature values.

At block 312, the machine learning model may be trained (e.g., by the computing device 102) to thereby generate the machine learning model. Techniques for training/generating the machine learning model may include gradient boosting, neural networks, deep learning, linear regression, polynomial regression, logistic regression, support vector machines, decision trees, random forests, nearest neighbors, or any other suitable machine learning technique. In some examples, computing device 102 implements gradient boosting machine learning with a secondary application of the model for close cases and/or error correction. In certain embodiments, training the machine learning model may include training more than one model according to the selected method(s) on the data pre-processed at block 308 implementing different method(s) and/or using different sub-sets of the training data, or according to other criteria.

Training the machine learning model may include re-running the model (at optional block 314) to improve the accuracy of prediction values. For example, re-running the model may improve model training when implementing gradient boosting machine learning. In another implementation, re-running the model may be necessary to assess the differences caused by an evaluation procedure. For instance, available data sets in the query device 140, the computing device 102, any of the data source servers 160A, 160B, 160C, and/or any other data source may be split into training and testing data sets by randomly assigning sub-sets of data to be used to train the model or evaluate the model to meet the predefined train or test set size, or an evaluation procedure may use a k-fold cross validation. Both of these evaluation procedures are stochastic, and, as such, each evaluation of a deterministic ML model, even when running the same algorithm, provides a different estimate of error or accuracy. The performance of these different model runs may be compared using one or more accuracy metrics, for example, as a distribution with mean expected error or accuracy and a standard deviation. In certain implementations, the models may be evaluated using metrics such as root mean square error (RMSE), to measure the accuracy of prediction values.

Regarding block 316, evaluating the model typically involves testing the model using testing data or validating the model using validation data. Testing/validation data typically includes both predictor feature values and target feature values (e.g., including order demand patterns for which corresponding delivery patterns are known), enabling comparison of target feature values predicted by the model to the actual target feature values, enabling one to evaluate the performance of the model. This testing/validation process is valuable because the model, when implemented, will generate target feature values for future input data that may not be easily checked or validated. Thus, it is advantageous to check one or more accuracy metrics of the model on data for which the target answer is already known (e.g., testing data or validation data), and use this assessment as a proxy for predictive accuracy on future data. Example accuracy metrics include key performance indicators, comparisons between historical trends and predictions of results, cross-validation with subject matter experts, comparisons between predicted results and actual results, etc.

Regarding block 318, the processor 120 may utilize any suitable set of metrics to determine whether or not to proceed to block 320 to output the final production model. Generally speaking, the decision to proceed to block 320 or to return to block 312 will depend on one or more accuracy metrics generated during evaluation (block 316). After the sub-blocks 312-318 of block 304 have been completed, the processor 120 may implement block 320. At block 320, the machine learning model is output.

### Exemplary Results—Square Footage & Year Built

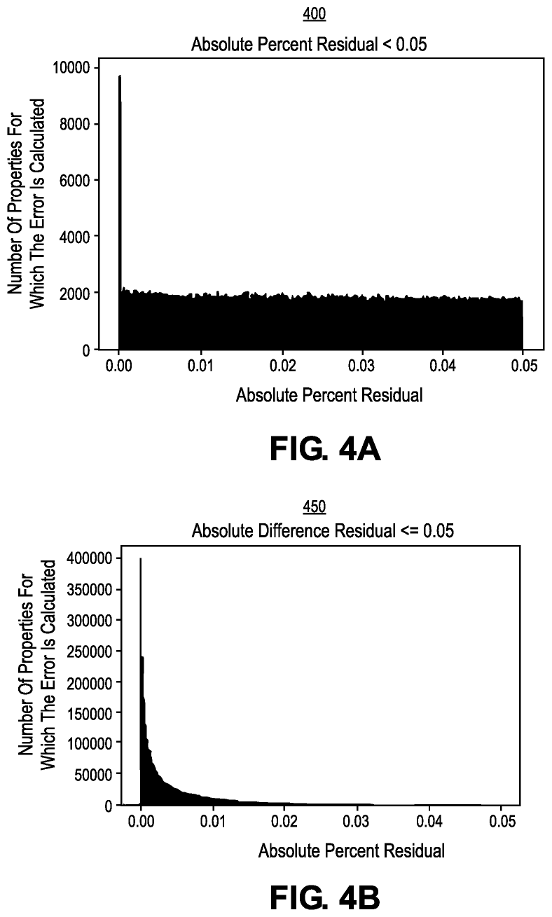

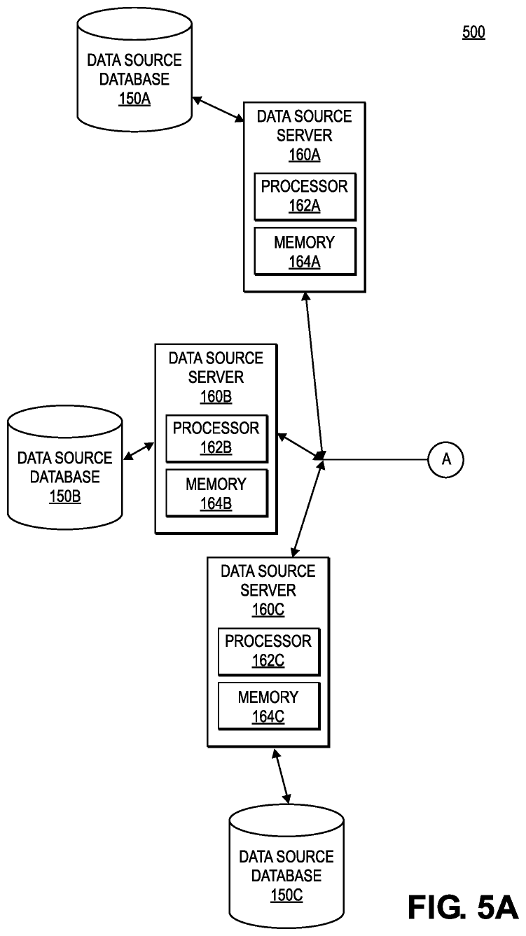

Exemplary simulations run in accordance with the techniques described herein produced very accurate results. For instance, FIG. 4A illustrates an example simulation of determining a square footage of a subject property (e.g., where the at least one property parameter is the square footage). In this example, the simulation was run on the seven nearest homes to a subject property based on longitude and latitude. As a metric of accuracy, an absolute percent residual was calculated, with the absolute percent residual being the absolute difference percent between the reported square footage and the predicted square footage (e.g., predicted by the machine learning algorithm in accordance with the principles discussed herein).

The exemplary graph 400 illustrates this graphically as the number of properties for which the error is calculated vs. absolute percent residual. Furthermore, as can be seen, 99% of the time, the predicted square footage generated by the model had an error of less than 5%. Further as can be seen, there was a large spike at zero percent error where the predicted square footage and the reported square footage essentially matched.

FIG. 4B illustrates an exemplary simulation of determining a year built of the subject property (e.g., where the at least one property parameter is the year built). In this example, the simulation was run on the seven nearest homes to a subject property based on longitude and latitude. As a metric of accuracy, an absolute percent residual was calculated, with the absolute percent residual being the absolute difference percent between the reported year built and the predicted year built (e.g., predicted by the machine learning algorithm in accordance with the principles discussed herein). The example graph 450 illustrates this graphically as number of properties for which the error is calculated vs. absolute percent residual. As can be seen, there was a large spike at zero percent error where the predicted year built and the reported square footage essentially matched.

### Exemplary Processing Implementations

FIGS. 5A and 5B illustrate an exemplary implementation 500. Similarly to FIG. 1, data from the data source servers 160A, 160B, 160C and/or data source databases 150A, 150B, 150C may be sent to the computing device 102. In some embodiments, the computing device 102 is implemented on a virtual personal computer (VPC).

More specifically, the data from the data source servers 160A, 160B, 160C and/or data source databases 150A, 150B, 150C may be received by the landing zone 133. In some embodiments, the landing zone 133 acts as a data lake, gathering data from various data sources, such as the data source servers 160A, 160B, 160C and/or data source databases 150A, 150B, 150C. The landing zone 133 may gather data from any suitable source, including those not illustrated in FIGS. 5A and 5B (e.g., aerial imager 170, etc.). The incoming data may be stored in any suitable format (e.g., .csv, .json, .xml, etc.). The landing zone 133 may store data in the landing zone database 510.

The transformation layer 134 imports the data from the landing zone 133, and performs transformations on the data to allow storage of the data in transformed database 520, such as a relational database (e.g., PostgreSQL, RDS/Aurora, etc.). To further explain, in some embodiments, the transformed database 520 is a relational database configured to present data as relations (e.g., in tabular form, such as by a collection of tables with each table including a set of rows and columns). The relational database may further provide relational operators to manipulate the data in tabular form.

In some embodiments, the transformed database 520, stores the data along with metadata, such as the data source the data was received from, and the date the data was received. The property parameters (e.g., stored in the transformed database 520) may be stored in a many-to-one relationship to each address in order to maintain a holistic view of the collected data.

Furthermore, the transformation layer 134 may send the data to the confidence modeling 525. The confidence modeling 525 may take information of properties (e.g., received from the transformation layer 134), and determine the at least one property parameter (e.g., in accordance with the techniques described herein, such as by applying a machine learning algorithm, averaging values from the properties, or using a weighted average, etc.).

In addition, the confidence modeling 525 may generate a property measurement based upon the at least one property parameter (e.g., by any suitable technique, such as by using a machine learning algorithm in accordance with the techniques discussed herein).

The Rest Service/WebApp 135 may store a final Digital Property Profile that may be provided to customers via a queriable application programming interface (API). Data may be stored in a relational database (e.g., rest service database 530) similar to the transformation layer database 520, but, in some implementations, property parameters are stored in a one-to-one relationship to each address. The value for each property parameter may be determined by a combination of modeling and business logic. The API allows customers/business partners to query the rest service database 530 (e.g., from the query device 140, such as a computer of an insurance agent) by property address, or by any other search parameters (e.g., range of property values, range of year built, range of square footage, etc.).

### Exemplary Computer-Implemented Methods for Property Measurement Determination

Broadly speaking, the computing device 102 may generate a property measurement for a subject property. In some embodiments, the generated property measurement is then used to determine an insurance quote (e.g., a homeowners insurance quote, a renter's insurance quote, and/or an umbrella policy quote, etc.).

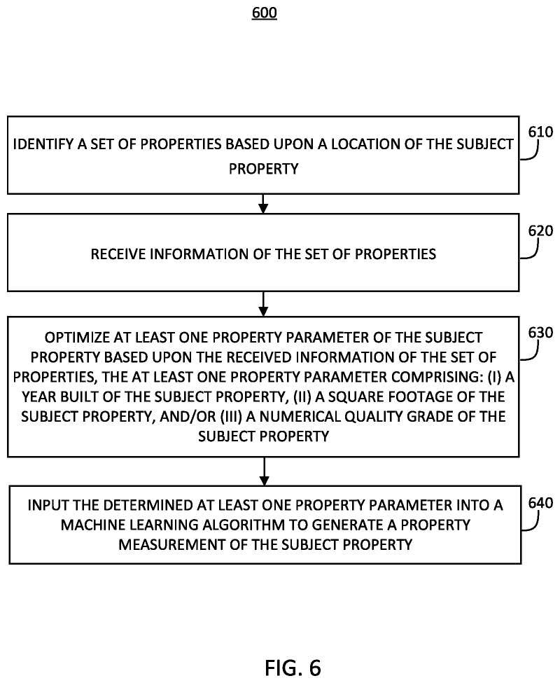

To this end, FIG. 6 shows an exemplary implementation 600 of generating a property measurement. It should be understood that the exemplary computer-implemented method 600 may include additional, fewer, or alternate actions, including those discussed elsewhere herein.

The property measurement may comprise any type of property measurement, such as a property value (e.g., an estimated price that the property would sell for), a construction replacement cost (e.g., an estimated cost to replace a structure on the property in the event of a total loss), a repair or replacement cost of various areas and/or fixtures of a partially damaged home or other property (e.g., damaged kitchen or bathroom), a property health score or other home profile, and/or an insurance premium (e.g. a homeowner's insurance premium). In some implementations, the property health score may be a score or rating of the condition and/or other features of the property. For instance, the property health score may be based upon, at least in part, if the property is likely to require maintenance (and, if so, how costly the maintenance would likely be). The property health score may also indicate a likelihood of damage to the property. For instance, a short proximity to a fire hydrant may indicate a lower likelihood of damage from a fire, and thus result in a higher property health score.

The exemplary implementation begins at block 610 where the computing device 102 identifies a set of properties (e.g., a set of properties nearby the subject property) based upon a location of the subject property.

The set of properties may be identified by any suitable technique. For instance, the set of properties may be identified by identifying a predetermined number of properties to be the closest properties to the subject property based upon latitude and longitude data. Additionally or alternatively, the set of properties may be identified via an iterative technique. For instance, the set of properties may be identified by: (i) initially, identifying properties with property boundaries in contact with property boundaries of the subject property; and (ii) subsequently, until a predetermined number of properties is reached, iteratively identifying properties by identifying next-closest properties, and adding the next-closest properties to the set of properties.

In another example, the set of properties may be identified by identifying properties within a predetermined distance from the location of the subject property to be the properties of the set of properties (e.g., the set of properties comprises any number of properties within the predetermined distance).

At block 620, information of the set of properties is received (e.g., by the computing device 102, the machine learning training application 126, the landing zone 133, the property parameter determiner 124, and/or the property measurement determiner 128, etc.). The information of the set of properties may be received from any suitable data source, such as a data source server(s) 160A, 160B, 160C, the query device 140, and/or the aerial imager 170. In some embodiments, a data source server 160A, 160B, 160C may comprise a server of a public tax assessor database, a public records database, a database of a real estate company, a database of an insurance company, a database of a property listing company, etc.

The information of the set of properties may include any information. For instance, the information of the set of properties may include any number of: the year built of the subject property, the square footage of the subject property, the quality grade of the subject property, a number of bathrooms of the subject property, roof information of the subject property, a number of stories of the subject property, a kitchen countertop material of the subject property, floor covering information of the subject property, property use information of the subject property, kitchen size information of the subject property, garage information of the subject property, cooling system information of the subject property, heating system information of the subject property, exterior wall finish information of the subject property, foundation type of the subject property, fireplace information of the subject property, and/or tax information of the subject property.

In some embodiments, the information of the set of properties comes from the aerial imager 170 (which may comprise a fleet of aerial imagers). The aerial imager 170 may gather information of the exterior and/or interior of the subject property and/or other properties by any suitable technique. For instance, the aerial imager 170 may be equipped with LIDAR camera(s), photographic camera(s), video camera(s), radio detection and ranging (RADAR) equipment, and/or infrared equipment. The aerial imager 170 may use any of the devices that it is equipped with to gather data of any property (e.g., the exterior or interior of the subject property), including the subject property. For instance, the aerial imager 170 may use a LIDAR camera to measure dimensions of the exterior of the subject property.

Furthermore, once the information of the set of properties is received (e.g., at block 620), the information may be transformed such that the transformed information of the set of properties is configured to be stored in a first relational database (e.g., transformed database 520).

At block 630, the computing device 102 optimizes at least one property parameter of the subject property based upon the received information of the set of properties. In some embodiments, the at least one property parameter may be any number of: year built, square footage, build grade, number of bathrooms, roof information, number of stories, kitchen countertop material, floor covering information, property use information, kitchen size, garage information (e.g., garage size and style information), cooling system information, heating system information, exterior wall finish information, foundation type, fireplace information, tax information, interior features, exterior features, proximity to a fire hydrant, etc. In some embodiments, the actual value of the at least one property parameter is unknown, and thus it is beneficial to optimize a value of the at least one property parameter to aid in the generation of the property measurement.

The optimization of the at least one property parameter may be done by any suitable technique. For instance, if the corresponding values of the at least one property parameter for nearby properties are in the received information of the set of properties, those values may be used to optimize the at least one property parameter. For example, values of properties of the set of properties may be averaged to optimize the at least one property parameter. For instance, if the at least one property parameter comprises kitchen size, the kitchen sizes of nearby properties may be averaged to optimize the at least one property parameter. Additionally or alternatively, a weighted average may be used. For instance, properties of the set of properties may be assigned weights with increasing value as proximity to the subject property increases.

If a property parameter does not directly have a numerical value, it may be assigned one. For instance, if the at least one property parameter comprises a foundation type, higher quality foundation types may be assigned higher numerical values, and lower quality foundation types may be assigned lower numerical values. In another example, the qualitative build grade may be assigned a numerical value (e.g., a higher qualitative build grade is assigned a higher numerical value, and a lower qualitative build grade is assigned a lower numerical value). Thus, these types of property parameters may be averaged and treated as numerical values as well.

In addition, if the at least one property parameter comprises more than one property parameter, the property parameters may be combined and/or averaged, etc. Additionally or alternatively, the property parameters may be kept separately, and then separately used in the generation of the property measurement of the subject property (e.g., at block 640).

Additionally or alternatively to using an average and/or a weighted average, the at least one property parameter may be optimized by inputting the information of the set of properties into a machine learning algorithm (e.g., a property parameter machine learning algorithm). The machine learning algorithm may be trained by any suitable technique, including those described above with respect to FIG. 3. The input to the machine learning algorithm may include any data from the information of the set of properties. For instance, if the property parameter to be optimized comprises the square footage, the square footage of nearby properties may be inputted into the machine learning algorithm to optimize the property parameter of the subject property.

However, this example is non-limiting, and any number of inputs may be used. For instance, to optimize the property parameter of square footage, the square footage of nearby properties along with other information of the nearby properties (e.g., information of any of the other possible property parameters, such as year built, build grade, number of bathrooms, roof information, number of stories, kitchen countertop material, floor covering information, property use information, kitchen size, garage information (e.g., garage size and style information), cooling system information, heating system information, exterior wall finish information, foundation type, fireplace information, tax information, interior features, exterior features, proximity to a fire hydrant, etc.) may be inputted into the machine learning algorithm to optimize the property parameter.

In one exemplary implementation, the at least one property parameter comprises the cooling system information, and/or the heating system information; and the input may be the year built of the subject property. In this regard, there may be a strong correlation between the year built and the heating/cooling system information because structures built within a certain time period are highly likely to be built with certain heating and/or cooling systems (e.g., forced air).

In addition, the optimization may involve data from different data sources (e.g., the data source databases 150A, 150B, 150C, the areal imager 170, etc.). In some implantations, the optimization may be based upon a hierarchy of the data sources. For instance, an aggregated data source may be higher in a hierarchy than a public records database; and thus, if there is a discrepancy between information received from the aggregated data source and the public records database, the property parameter may be optimized to be the information received from the aggregated data source. In another example, the aerial imager 170 may be higher in a hierarchy than the aggregated data source; and thus, if there is a discrepancy between information received from the aerial imager 170 and the aggregated data source, the property parameter may be optimized to be the information received from the areal imager 170.

Furthermore, in implementations with data from different data sources, the optimization may comprise averaging the information received from the different data sources and/or using a machine learning algorithm to optimize the parameter. For instance, if different data sources indicate different years built of the subject property, the different years built may all be input into the property parameter machine learning algorithm so that the optimization of the year built of the subject property is based upon all of the different years built indicated by the various data sources.

At block 640, a property measurement of the subject property based upon the optimized at least one property parameter is generated. The property measurement may be generated by any suitable technique, such as by inputting the property parameter (e.g., with or without with other data) into a machine learning algorithm (e.g., as discussed above with respect to FIG. 3). It may be noted that by optimizing the property parameter (e.g., in accordance with the techniques described herein) so that a value is inputted into the machine learning algorithm (e.g., rather than a blank or undetermined value; or an outdated or inaccurate value, etc.), the accuracy of the generated property measurement of the subject property is greatly increased.

Furthermore, a digital profile of the subject property may be built based upon the generated property measurement of the subject property. The digital profile may be stored in a second relational database (e.g., stored by a rest service in rest service database 530).

It should be understood that the example method 600 may include additional, fewer, or alternate actions, including those discussed elsewhere herein.

### Exemplary Trusted Digital Property Profile Generation

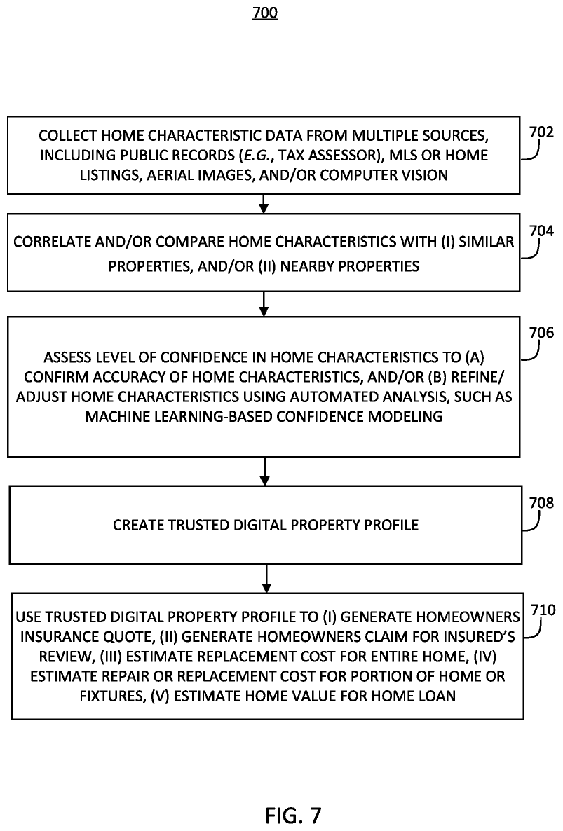

FIG. 7 illustrates a computer-implemented method of creating a trusted property profile 700. The method may be implemented via one or more local or remote processors, servers, sensors, transceivers, memory units, aerial units, and/or other components.

The computer-implemented method 700 may include, via one or more processors and/or transceivers, collecting, generating, or gathering home characteristic data and/or home images from multiple sources 702. The home characteristics defined or identified by the data and images may include those discussed herein, such as home square footage, build grade, year built, roof type, number of bathrooms, kitchen countertop material, etc. The home characteristic data and/or home images may be collected or retrieved from (a) public records (e.g., tax assessor data); (b) MLS or other home listings (such as online home listings); (c) aerial image databases, and/or (d) computer vision images or data. Additionally or alternatively, new home characteristic data and/or home images may be acquired by and received (via wireless communication or data transmission) from (i) home mounted sensors or cameras, (ii) mobile devices and/or mobile device cameras, (iii) smart vehicle or smart vehicle cameras, (iv) smart infrastructure, such as street light mounted cameras, (v) manned or unmanned aerial vehicles, such as drones, and/or other sources.

In some embodiments, the home characteristic data may include known or previously determined home characteristics and relative confidence levels thereof. Additionally or alternatively, the home characteristic data and/or home images may be analyzed by one or more processors and/or algorithms (such as using machine learning or other techniques) to determine or estimate initial home characteristics and/or refine previous or existing home characteristics. For instance, drone images may be used to refine or update roof square footage, size, and/or material. In some embodiments, some home characteristics may be left blank or undetermined after initial data retrieval and analysis.

The computer-implemented method 700 may include, via one or more processors, correlating and/or comparing the home characteristics retrieved, estimated, or undetermined with (i) similar properties, and/or (ii) nearby properties 704 for refinement. For instance, some home characteristics may be unreliable or inaccurate, or even undefined. If those home characteristics are known for similar or nearby properties, the home characteristics for a home may be given the home characteristics that is/are known for one or more similar or nearby properties.

For instance, countertop material or kitchen flooring material for a given home may be unknown. However, the countertop material and kitchen flooring material for a nearby home may be known. If so, the nearby home's countertop and flooring characteristics may be assigned to the given home as a rough estimate.

The computer-implemented method 700 may include, via one or more processors, assessing the level of confidence in home characteristics to (a) confirm the accuracy of home characteristics, and/or (b) refine or adjust the home characteristics using automated analysis, such as machine learning-based confidence modeling 706. For instance, the processors may analyze the home characteristic data and/or home images received or generated to confirm known home characteristics, or update home characteristics, as well as to assess the level of confidence in the home characteristics known and/or estimated. In some embodiments, the home characteristic data and/or home images may be input into one or more machine learning models to refine and/or estimate the home characteristics of a given home, and/or determine the confidence level thereof. In certain embodiments, home characteristic data of similar or nearby properties may also be input into the one or more machine learning models to refine and/or estimate the home characteristics of the given home, and determine the confidence level of the home characteristics determined or estimated.

The computer-implemented method 700 may include, via one or more processors, creating a trusted digital property profile 708. As noted above and elsewhere herein, machine learning techniques may be applied to (and/or other automated analysis of) the home characteristic data and/or home images to create a home profile or digital property profile. The digital property profile may be assigned a confidence level, and may be assigned a “trusted” value if the confidence level is at or above a predetermined level, such as 90% confident in the accuracy of the home characteristics determined or estimated.

The computer-implemented method 700 may include, via one or more processors and/or transceivers, using the trusted digital property profile for several practical applications 710. For instance, as discussed elsewhere herein, the digital property profile may be utilized to (i) generate a homeowners insurance quote and policy; (ii) generate a homeowners insurance claim for the insured's review in the event of damage to the home; (iii) estimate a replacement cost for the entire home in the case of a total loss; (iv) estimate a repair or replacement cost for the home or a portion thereof, and any fixtures located on the home or property; and/or (v) estimate a value or appraisal for a home, such as for use in generating a home loan. The computer-implemented method 700 may include additional, less, or alternative functionality and actions, including those discussed elsewhere herein.

### Exemplary Property Measurement Optimization

In one aspect, a computer-implemented method for use in generating a property measurement of a subject property may be provided. The method may include: (1) identifying, by one or more processors, a set of properties based upon a location of the subject property; (2) receiving, by the one or more processors, information of the set of properties; and/or (3) optimizing, by the one or more processors, at least one property parameter of the subject property based upon the received information of the set of properties, the at least one property parameter comprising: (i) a year built of the subject property, (ii) a square footage of the subject property, and/or (iii) a qualitative build grade of the subject property. The method may include additional, fewer, or alternate actions, including those discussed elsewhere herein.

In some embodiments, the at least one property parameter may include the year built of the subject property; and the optimizing the at least one property parameter may include computing an average year built of the set of properties based upon the received information of the set of properties, and setting the year built of the subject property to be the computed average year built of the set of properties.

In some implementations, the at least one property parameter may include the year built of the subject property; and the optimizing the at least one property parameter may include: (i) computing, based upon the received information of the set of properties, a weighted average year built of the set of properties by setting weights to properties of the set of properties with the weights increasing as the corresponding properties increase in proximity to the subject property, and (ii) setting the year built of the subject property to be the computed weighted average year built of the set of properties.

In some embodiments, the at least one property parameter may include the year built of the subject property; and the optimizing the at least one property parameter may include inputting the information of the set of properties into a property parameter machine learning algorithm to determine the year built of the subject property.

In some implementations, the at least one property parameter may include the square footage of the subject property; and the optimizing the at least one property parameter may include computing an average square footage of the set of properties based upon the received information of the set of properties, and setting the square footage of the subject property to be the computed average square footage of the set of properties.

In some embodiments, the at least one property parameter may include the square footage of the subject property; and the optimizing the at least one property parameter may include: (i) computing, based upon the received information of the set of properties, a weighted average square footage of the set of properties by setting weights to properties of the set of properties with the weights increasing as the corresponding properties increase in proximity to the subject property, and (ii) setting the square footage of the subject property to be the computed weighted average square footage of the set of properties.

In some implementations, the at least one property parameter may include the square footage of the subject property; and the optimizing the at least one property parameter may include inputting the information of the set of properties into a property parameter machine learning algorithm to determine the square footage of the subject property.

In some embodiments, the at least one property parameter may include the qualitative build grade of the subject property; and the optimizing the at least one property parameter may include computing an average qualitative build grade of the set of properties based upon the received information of the set of properties, and setting the qualitative build grade of the subject property to be the computed average qualitative build grade of the set of properties.

In some implementations, the at least one property parameter may include the qualitative build grade of the subject property; and the optimizing the at least one property parameter may include: (i) computing, based upon the received information of the set of properties, a weighted average qualitative build grade of the set of properties by setting weights to properties of the set of properties with the weights increasing as the corresponding properties increase in proximity to the subject property, and (ii) setting the qualitative build grade of the subject property to be the computed weighted average qualitative build grade of the set of properties.

In some embodiments, the method further comprises inputting, by the one or more processors, the optimized at least one property parameter into a property measurement machine learning algorithm or other model to generate (i) a property value of the subject property (e.g., a home), and/or (ii) a repair or replacement cost for the property (e.g., a home), a portion of the property, or a fixture or other item on the property. The property value of the home may be used in generating a homeowners insurance quote and policy. The repair or replacement cost may be used to generate a pre-populated insurance claim for an insured and/or handle/process an insurance claim for damaged or partially damaged home.

In some implementations, the method further comprises inputting, by the one or more processors, the optimized at least one property parameter into a property measurement machine learning algorithm or other model to generate a property health score or home profile of the subject property. The property health score or home profile may used to generate a homeowners insurance quote or policy for a home, and/or generate a pre-populated insurance claim for an insured and/or handle/process an insurance claim for damaged or partially damaged home.

In some embodiments, the method further may include gathering, with an aerial imager, measurement data of an exterior of a structure of the subject property; and wherein the at least one property parameter comprises the square footage of the subject property; and wherein the optimizing the at least one property parameter may include inputting the information of the set of properties along with the measurement data of the exterior of the structure into a property parameter machine learning algorithm to determine the square footage of the subject property.

In some implementations, the method further may include: at a transformation layer of the one or more processors, transforming the information of the set of properties such that the transformed information of the set of properties is configured to be stored in a first relational database; storing, by the one or more processors, the transformed information in the first relational database; building, by the one or more processors, a digital profile of the subject property based upon a generated property measurement of the subject property; and with a rest service of the one or more processors, storing the digital profile in a second relational database.

In another aspect, a computer system configured for use in generating a property measurement of a subject property may be provided. The computer system may comprise one or more processors configured to: (1) identify a set of properties based upon a location of the subject property; (2) receive information of the set of properties; and/or (3) optimize at least one property parameter of the subject property based upon the received information of the set of properties, the at least one property parameter comprising: (i) a year built of the subject property, (ii) a square footage of the subject property, and/or (iii) a qualitative build grade of the subject property. The computer system may include additional, less, or alternate functionality, including that discussed elsewhere herein.

In some embodiments, the at least one property parameter may include the qualitative build grade of the subject property; the information of the set of properties comprises any number of: (i) the year built of the subject property, (ii) the square footage of the subject property, (iii) a number of bathrooms of the subject property, (iv) roof information of the subject property, (v) a number of stories of the subject property, (vi) a kitchen countertop material of the subject property, (vii) floor covering information of the subject property, (viii) property use information of the subject property, (ix) kitchen size information of the subject property, (x) garage information of the subject property, (xi) cooling system information of the subject property, (xii) heating system information of the subject property, (xiii) exterior wall finish information of the subject property, (xiv) foundation type of the subject property, (xv) fireplace information of the subject property, and/or (xvi) tax information of the subject property; and the one or more processors are configured to optimize the at least one property parameter by inputting the information of the set of properties into a property parameter machine learning algorithm to optimize the qualitative build grade of the subject property.

In some implementations, the one or more processors are configured to identify of the set of properties by identifying a predetermined number of properties to be the closest properties to the subject property based upon latitude and longitude data.

In some embodiments, the one or more processors are configured to identify of the set of properties by identifying properties within a predetermined distance from the location of the subject property to be the properties of the set of properties.

In some implementations, the one or more processors are configured to identify of the set of properties by: initially, identifying properties with property boundaries in contact with property boundaries of the subject property as part of the set of properties; and subsequently, until a predetermined number of properties is reached, iteratively identifying properties by identifying next-closest properties, and adding the next-closest properties to the set of properties.

In some embodiments, the one or more processors may be configured to input the optimized at least one property parameter into a property measurement machine learning algorithm or other model to generate (i) a property value of the subject property (e.g., a home), and/or (ii) a repair or replacement cost for the property (e.g., a home), a portion of the property, or a fixture or other item on the property. The property value of the home may be used in generating a homeowners insurance quote and policy. The repair or replacement cost may be used to generate a pre-populated insurance claim for an insured and/or handle/process an insurance claim for damaged or partially damaged home.

In some implementations, the one or more processors may be configured to input the optimized at least one property parameter into a property measurement machine learning algorithm or other model to generate a property health score or home profile of the subject property. The property health score or home profile may used to generate a homeowners insurance quote or policy for a home, and/or generate a pre-populated insurance claim for an insured and/or handle/process an insurance claim for damaged or partially damaged home.

In yet another aspect, a computer system for generating a property measurement of a subject property may be provided. The computer system may include one or more local or remote processors, servers, transceivers, sensors, and/or memory units. In one embodiment, the computer system may include one or more processors. The computer system may further comprise a program memory coupled to the one or more processors and storing executable instructions that, when executed by the one or more processors, cause the computer system to: (1) identify a set of properties based upon a location of the subject property; (2) receive information of the set of properties; and/or (3) optimize at least one property parameter of the subject property based upon the received information of the set of properties, the at least one property parameter comprising: (i) a year built of the subject property, (ii) a square footage of the subject property, and/or (iii) a qualitative build grade of the subject property. The non-transitory computer readable medium may include instructions that direct additional, less, or alternate functionality, including that discussed elsewhere herein.

In some embodiments, the instructions, when executed by the one or more processors, further cause the computer system to receive the information of the set of properties from a public tax assessor database.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘ ’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for use in determining a property parameter of a subject property when the property parameter is unknown or inaccurate, the method comprising:
obtaining, by one or more processors, an indication of a known property parameter of each of a first set of properties;
obtaining, by the one or more processors, home characteristic data for home characteristics of each of the first set of properties;
training, by the one or more processors, a machine learning algorithm to determine a property parameter of a property when the property parameter is unknown or inaccurate using the home characteristic data of the first set of properties and the known property parameter of each of the first set of properties;
identifying, by one or more processors, a subject property having an unknown or inaccurate property parameter;
obtaining, by the one or more processors, home characteristic data for the subject property for the home characteristics used to train the machine learning algorithm; and
applying, by the one or more processors, the home characteristic data for the subject property to the trained machine learning algorithm to determine the property parameter of the subject property.

2. The computer-implemented method of claim 1, wherein the property parameter is a square footage, a number of stories, a qualitative build grade, a year built, or a garage size.

3. The computer-implemented method of claim 1, further comprising:
obtaining, by the one or more processors, one or more home images of each of the first set of properties, wherein the machine learning algorithm is further trained using the one or more home images of each of the first set of properties;
obtaining, by the one or more processors, one or more home images of the subject property; and
applying, by the one or more processors, the home characteristic data and the one or more homes image of the subject property to the trained machine learning algorithm to determine the property parameter of the subject property.

4. The computer-implemented method of claim 3, further comprising:
extracting, by the one or more processors, one or more features of the one or more home images of each of the first set of properties, wherein the machine learning algorithm is trained using the one or more features of the one or more home images of each of the first set of properties.

5. The computer-implemented method of claim 3, further comprising:
gathering measurement data of an exterior of a structure of the subject property based upon the one or more home images of the subject property.

6. The computer-implemented method of claim 1, further comprising:
applying, by the one or more processors, the home characteristic data of the subject property to the trained machine learning algorithm to determine a confidence level for the determination of the property parameter of the subject property.

7. The computer-implemented method of claim 1, wherein training the machine learning algorithm to determine the property parameter includes:
training, by the one or more processors, a first machine learning algorithm to determine a number of stories;
training, by the one or more processors, a second machine learning algorithm to determine a square footage; and
training, by the one or more processors, a third machine learning algorithm to determine a qualitative build grade.

8. A computer system configured for use in determining a property parameter of a subject property when the property parameter is unknown or inaccurate, the computer system comprising one or more processors configured to:
obtain an indication of a known property parameter of each of a first set of properties;
obtain home characteristic data for home characteristics of each of the first set of properties;
train a machine learning algorithm to determine a property parameter of a property when the property parameter is unknown or inaccurate using the home characteristic data of the first set of properties and the known property parameter of each of the first set of properties;
identify a subject property having an unknown or inaccurate property parameter;
obtain home characteristic data for the subject property for the home characteristics used to train the machine learning algorithm; and
apply the home characteristic data for the subject property to the trained machine learning algorithm to determine the property parameter of the subject property.

9. The computer system of claim 8, wherein the property parameter is a square footage, a number of stories, a qualitative build grade, a year built, or a garage size.

10. The computer system of claim 8, wherein the processors are further configured to:
obtain one or more home images of each of the first set of properties, wherein the machine learning algorithm is further trained using the one or more home images of each of the first set of properties;
obtain one or more home images of the subject property; and
apply the home characteristic data and the one or more homes image of the subject property to the trained machine learning algorithm to determine the property parameter of the subject property.

11. The computer system of claim 10, wherein the processors are further configured to:
extract one or more features of the one or more home images of each of the first set of properties, wherein the machine learning algorithm is trained using the one or more features of the one or more home images of each of the first set of properties.

12. The computer system of claim 10, wherein the processors are further configured to:
gather measurement data of an exterior of a structure of the subject property based upon the one or more home images of the subject property.

13. The computer system of claim 8, wherein the processors are further configured to:
apply the home characteristic data of the subject property to the trained machine learning algorithm to determine a confidence level for the determination of the property parameter of the subject property.

14. The computer system of claim 8, wherein to train the machine learning algorithm to determine the property parameter, the processors are configured to:
train a first machine learning algorithm to determine a number of stories;
train a second machine learning algorithm to determine a square footage; and
train a third machine learning algorithm to determine a qualitative build grade.

15. A non-transitory computer-readable memory storing instructions thereon, that when executed by one or more processors, cause the one or more processors to:
obtain an indication of a known property parameter of each of a first set of properties;
obtain home characteristic data for home characteristics of each of the first set of properties;
train a machine learning algorithm to determine a property parameter of a property when the property parameter is unknown or inaccurate using the home characteristic data of the first set of properties and the known property parameter of each of the first set of properties;
identify a subject property having an unknown or inaccurate property parameter;
obtain home characteristic data for the subject property for the home characteristics used to train the machine learning algorithm; and
apply the home characteristic data for the subject property to the trained machine learning algorithm to determine the property parameter of the subject property.

16. The non-transitory computer-readable memory of claim 15, wherein the property parameter is a square footage, a number of stories, a qualitative build grade, a year built, or a garage size.

17. The non-transitory computer-readable memory of claim 15, wherein the instructions further cause the one or more processors to:
obtain one or more home images of each of the first set of properties, wherein the machine learning algorithm is further trained using the one or more home images of each of the first set of properties;
obtain one or more home images of the subject property; and
apply the home characteristic data and the one or more homes image of the subject property to the trained machine learning algorithm to determine the property parameter of the subject property.

18. The non-transitory computer-readable memory of claim 17, wherein the instructions further cause the one or more processors to:
extract one or more features of the one or more home images of each of the first set of properties, wherein the machine learning algorithm is trained using the one or more features of the one or more home images of each of the first set of properties.

19. The non-transitory computer-readable memory of claim 17, wherein the instructions further cause the one or more processors to:
gather measurement data of an exterior of a structure of the subject property based upon the one or more home images of the subject property.

20. The non-transitory computer-readable memory of claim 15, wherein the instructions further cause the one or more processors to:
apply the home characteristic data of the subject property to the trained machine learning algorithm to determine a confidence level for the determination of the property parameter of the subject property.
